(19) United States
(12) Patent Application Publication
(10) Pub. No.: US 2019/0139134 A1
(43) Pub. Date: May 9, 2019

(54) SYSTEM AND METHOD FOR THE GENERATION AND USE OF LOCAL FORMULAS FOR INFORMED DECISION-MAKING

(71) Applicant: Informed, Inc., San Francisco, CA (US)

(72) Inventor: Justin Wickett, San Francisco, CA (US)

(21) Appl. No.: 15/807,467

(22) Filed: Nov. 8, 2017

(51) Int. Cl. G06Q 40/02; G06Q 30/06

(52) U.S. Cl. CPC G06Q 40/025; G06Q 30/0247; G06Q 30/0609

(57) ABSTRACT

A system and method for the generation and use of local formulas for informed decision-making is disclosed. A particular embodiment includes: establishing, by use of a data processor and a data network, a data connection with at least one seller platform and at least one lender platform; at the seller platform, generating a set of purchase and loan parameters in an initial loan pre-qualification application; sending the initial loan pre-qualification application via the data connection to the at least one lender platform; receiving via the data connection from the at least one lender platform a customized formula-based decision computation module in response to the initial loan pre-qualification application, the customized formula-based decision computation module including loan criteria corresponding to the purchase and loan parameters in the initial loan pre-qualification application, the customized formula-based decision computation module being configured for local execution at the seller platform; executing the customized formula-based decision computation module locally at the seller platform to generate loan terms based on the purchase and loan parameters and the loan criteria; and generating a user interface at the seller platform to present a set of purchase options, the purchase options conforming to the purchase and loan parameters and the loan terms computed locally by the customized formula-based decision computation module.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016-2017 Informed, Inc., All Rights Reserved.

### TECHNICAL FIELD

This patent application relates to computer-implemented software systems, according to one embodiment, and more specifically to a system and method for the generation and use of local formulas for informed decision-making.

### BACKGROUND

It is common for automobile shoppers to purchase vehicles on credit from a lender using vehicle financing. In most cases, the interest rate being charged, the monthly payments required for the financing, the amount of the down payment, and the duration of the loan (e.g., the loan terms) can be as important to the purchaser as the cost of the vehicle. However, vehicle financing has become very complicated and difficult to manage for both the purchaser and the seller. One complicating factor is that multiple parties are involved in a typical vehicle loan: the buyer, seller, dealer, lenders, credit reporting agencies, underwriters, insurers, vehicle valuation experts, regulatory agencies, and the like. In today's typical financing process, any time a car shopper decides to change the amount they want to finance, their loan terms, or the particular vehicle they want to purchase, a new loan application must be created by the dealer and submitted to all lenders for decisioning. This is because each of these factors affects the interest rate and monthly payment amount that the lender will offer. However, submitting loan applications is costly and time consuming because of transmission fees, data pulls, manual underwriting labor, and compliance with numerous state and federal regulations including the Fair Credit Reporting Act (FCRA). Additionally, loan application credit checks may have negative implications for buyers. As a result, vehicle financing using conventional processes is inefficient, costly, time-consuming, and can lead to lost sales and unhappy purchasers and sellers.

### SUMMARY

In various example embodiments described herein, a system and method for the generation and use of local formulas for informed decision-making is disclosed. In the various example embodiments described herein, a computer-implemented tool or software application (app) as part of a financing facilitation system is described to automate and improve vehicle financing and the related decision-making processes. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system.

The financing facilitation system of the various example embodiments described herein enables car shoppers to see multiple accurate financing offers from different lenders across a dealer's entire inventory without needing to submit separate loan applications for every single possible combination of vehicle, down payment, and loan terms. The financing facilitation system also allows a single lender to present an applicant/co-applicant with rates and monthly payments that can be computed locally (e.g., at the purchase location), on-the-fly, for every possible combination of down payment and loan terms for any qualifying vehicle in their dealers' inventories. The result is a more transparent car shopping experience for the consumer and dealer as well a lower cost to fund for the lender.

The financing facilitation system described herein helps buyers obtain vehicle financing for desired vehicles without multiple credit checks. The financing facilitation system helps sellers to market their vehicles to pre-qualified buyers who are actively looking to buy a comparable vehicle for sale. No other solution in the industry has a process for ingesting a lender's dealer inventory and enabling prospective borrowers to see their exact personalized financing terms in the context of each vehicle they qualify for within seconds. Furthermore, no other solution enables a prospective borrower to adjust their desired down payment along with their desired loan terms and instantly see how such changes impact their monthly payment and rate for a specific car without having to pass information back to the lender for decisioning.

### BRIEF DESCRIPTION OF THE DRAWINGS

The various embodiments are illustrated by way of example, and not by way of limitation, in the figures of the accompanying drawings in which:

FIG. 1 illustrates an example embodiment of a networked system in which various embodiments may operate;

FIGS. 2 through 6 illustrate the lender or loan criteria embodied in the formula-based decision computation module of an example embodiment;

FIG. 7 is a sequence diagram that illustrates the interactions between the buyer platforms, the seller platforms, and the financial institution or lender platforms for a typical transaction in an example embodiment;

FIGS. 8 and 9 illustrate an example of a user interface presented to an applicant/buyer at an applicant/buyer platform in an example embodiment;

FIG. 10 illustrates another example embodiment of a networked system in which various embodiments may operate;

FIG. 11 illustrates a processing flow diagram that illustrates an example embodiment of a method as described herein; and

FIG. 12 shows a diagrammatic representation of a machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In various example embodiments, a system and method for the generation and use of local formulas for informed decision-making is disclosed. In the various example embodiments described herein, a computer-implemented tool or software application (app) as part of a financing facilitation system is described to automate and improve vehicle financing and the related decision-making processes. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system.

The financing facilitation system of the various example embodiments described herein enables car shoppers to see multiple accurate financing offers from different lenders across a dealer's entire inventory without needing to submit separate loan applications for every single possible combination of vehicle, down payment, and loan term. The financing facilitation system also allows a single lender to present an applicant/co-applicant with rates and monthly payments that can be computed locally, on-the-fly, for every possible combination of down payment and loan term for any qualifying vehicle in their dealers' inventories. The result is a more transparent car shopping experience for the consumer and dealer as well a lower cost to fund for the lender.

Using the financing facilitation system of the various example embodiments described herein, lenders receive information regarding the applicant and co-applicant and respond back with a formula-based decision computation module that locally produces lender-specific financing information that is independent of any specific collateral, amount financed, term, and down payment. As a result, the applicant and co-applicant can change the loan terms and even the vehicle being purchased on-the-fly and still readily obtain a lender's financing approval. In one example embodiment, this formula-based decision computation module can be represented in the form of an Excel™ spreadsheet, using financial formulas associated with investments, payments, interest, rates of return, yield, depreciation, amortization, and duration. The formula-based decision computation module provided by the lender can be used locally (e.g., at the purchase location) to generate an approved monthly payment, rate, term, discount, and participation based on a specific vehicle (e.g., a vehicle identification number [VIN], make, model, trim, year manufactured, mileage, color, options, retailer, location, fair market value, etc.), down payment, term, amount financed (specific to the vehicle itself, taxes, fees, and back-end products, including, but not limited to Guaranteed Asset Protection [GAP] waivers, Vehicle Service Contracts [VSCs], and Credit Life and Disability Insurance). The inputs and outputs associated with a sample formula-based decision computation module are described in more detail below. By locally generating the outputs of a formula-based decision computation module, results in terms of which vehicles a consumer qualifies to finance can be computed faster at a lower cost with reliance on fewer external resources. Furthermore, lenders do not have to share their entire proprietary decisioning logic beyond how collateral, amount financed, term, and down payment will affect their decision to lend to a consumer.

Formula-based decisions can be even more valuable to the recipient if they closely match a lender's firm offer of credit for a specific vehicle, amount financed, down payment, and loan term. To achieve this accuracy, lenders may require certain information from an applicant and co-applicant to look up credit scores (e.g., Fair, Isaac and Company [FICO]) and credit attributes associated with consumer reports. This applicant information may include the applicant and co-applicant's first and last name, physical address of primary residence, Social Security Number (SSN) and/or International Taxpayer Identification Number (ITIN), and date of birth. The lender may also request from the applicant and co-applicant information pertaining to their housing type, monthly housing expense, gross annual income, additional income, and/or net worth, which can be used to calculate factors such as debt-to-income ratio, payment-to-income ratio, and other applicant/co-applicant-specific variables (such as custom underwriting scores). Other applicant information such as time at residence, employment type, employer's name, job title, and time at job may be collected by the lender on an as-needed basis should it impact the vehicles, amounts financed, rates, terms, and monthly payments for which an applicant (and/or co-applicant) would qualify. Although each of these factors may affect an applicant/co-applicant's financing terms, many lenders wish to avoid sharing consumer report data with third parties to avoid additional regulations that are associated with Consumer Reporting Agencies (CRAs). Such regulation comes with substantial compliance costs and increased business operational complexity. A formula-based decision computation module provided by the lender can incorporate applicant-specific inputs computed based on FICO scores and consumer report attributes without needing to share the values themselves.

Lenders who obtain permissible purpose after receiving written instruction from the consumer to access their consumer report for pre-qualification and NOT for an application of credit stand to gain additional benefits from local formula-based decisioning. Because the consumer is not requesting to apply for credit, the lender is not subject to the requirements under the Fair Credit Reporting Act (FCRA) and other federal and state regulations. Otherwise, the lender would have to comply with all regulations associated with receiving and processing a loan application for each vehicle, amount financed, loan term, and down payment amount about which the applicant/co-applicant inquires. These individual loan applications cause the lender to incur processing costs associated with adverse action notices, counter offers, risk-based pricing notices, and approval notices, which have to be generated and stored in compliance with state and federal law for every single loan application. By generating a formula-based decision computation module after having received a consumer's written instruction to access their consumer report for pre-qualification, the lender can limit the number of applications of credit it receives that result in costly compliance policies and procedures that must be followed.

The financing facilitation system described herein helps buyers obtain vehicle financing for desired vehicles without multiple credit checks. The financing facilitation system helps sellers to market their vehicles to pre-qualified buyers who are actively looking to buy a comparable vehicle for sale. No other solution in the industry has a process for ingesting a lender's dealer inventory and enabling prospective borrowers to see their exact personalized financing terms in the context of each vehicle they qualify for within seconds. Furthermore, no other solution enables a prospective borrower to adjust their desired down payment along with their desired loan term and instantly see how such changes impact their monthly payment and rate for a specific car without having to pass information back to the lender for decisioning.

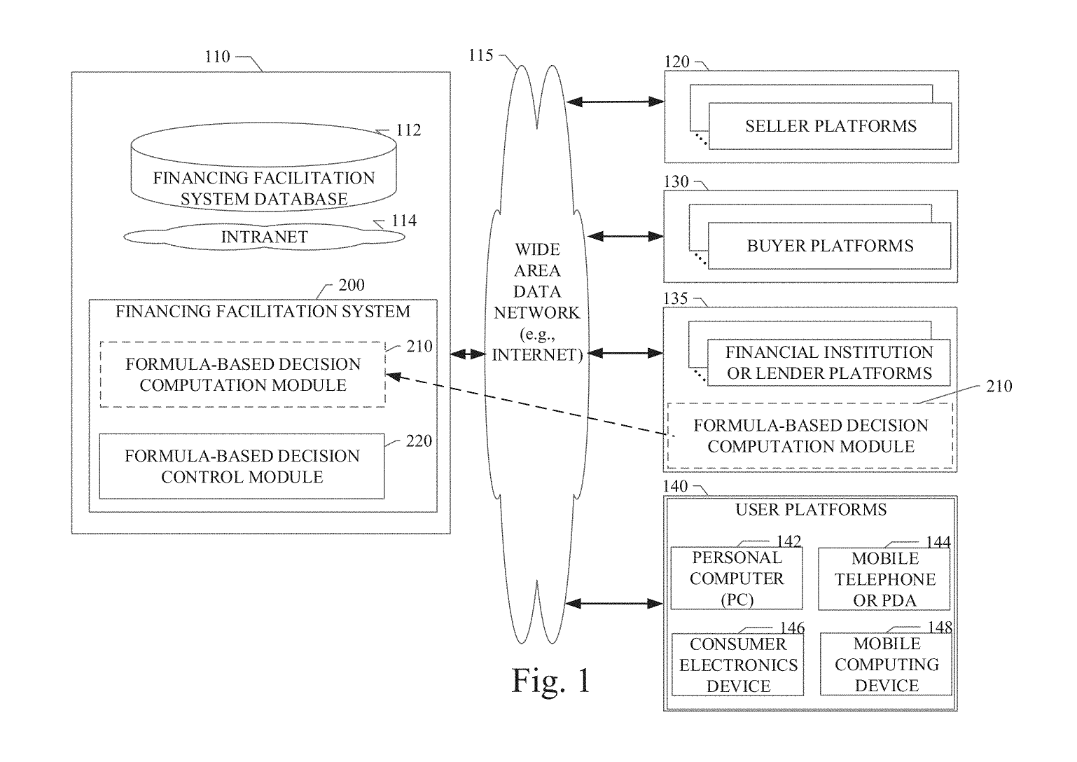

FIG. 1, in an example embodiment, illustrates a system enabling the generation and use of local formulas for informed decision-making. In various example embodiments, an application or service, typically provided by or operating on a host site (e.g., a website) 110, is provided to simplify and facilitate the downloading or hosted use of the financing facilitation system 200 of an example embodiment. In a particular embodiment, the financing facilitation system 200 can be downloaded from the host site 110 by a user at a user platform 140. Alternatively, the financing facilitation system 200 can be hosted by the host site 110 for a networked user at a user platform 140. The details of the financing facilitation system 200 for an example embodiment are provided below.

Referring again to FIG. 1, the financing facilitation system 200 can be in network communication with a plurality of seller platforms 120 and/or buyer platforms 130. The seller platforms 120 can include user platform computing and/or communication devices, websites, or other network resources at which product sellers or brokers operate or at which information regarding sellers and products (e.g., vehicles) offered for sale is available. The financing facilitation system 200 can be configured to provide data communications for the user platforms serving as networked platforms for product sellers/brokers and to obtain seller information and product information in a digital or computer-readable form via the network 115. The buyer platforms 130 can include user platform computing and/or communication devices configured to serve as networked platforms for product buyers and to obtain buyer information regarding consumers (e.g., potential product buyers), consumer financing information, consumer characteristics, consumer activities, or other buyer information. The financing facilitation system 200 can be configured to obtain this buyer information in a digital or computer-readable form via the network 115. The financing facilitation system 200 can also be in network data communication with a plurality of other information sites, such as consumer data or credit reporting platforms, and/or product valuation or rating sites. These types of on-line consumer data or credit reporting sites and product valuation or rating sites are well known to those of ordinary skill in the art.

The financing facilitation system 200 can also be in network data communication with a plurality of on-line financial institution or lender sites 135. The financing facilitation system 200 be configured to provide data communications for the user platforms or websites serving as networked platforms for on-line financial institutions or lenders and to obtain potential buyer-related financing, loan, or credit information in a digital or computer-readable form from one or more of the on-line financial institution or lender platforms 135 via the network 115. The financing facilitation system 200 be also be configured to provide data communications for the on-line financial institution or lender platforms 135 to enable the networked usage, transfer, or downloading of a formula-based decision computation module 210. As illustrated in FIG. 1, the formula-based decision computation module 210 is shown with dashed lines to indicate that the formula-based decision computation module 210 may initially reside with a financial institution or lender 135. In various example embodiments, each of the plurality of financial institutions or lenders 135 may develop or obtain one or more formula-based decision computation modules 210, which embody the particular lender's criteria for defining and approving loan terms for buyers at buyer platforms 130. The lender or loan criteria embodied in the formula-based decision computation module 210 is described in more detail below. As illustrated in FIG. 1, the formula-based decision computation module 210 is shown with dashed lines in the financing facilitation system 200 to indicate that the formula-based decision computation module 210 may be used, transferred, or downloaded to the host site 110 and the financing facilitation system 200 therein via the network 115. As such, the formula-based decision computation module 210 may be locally resident and locally used by a seller at seller platform 120 and/or a buyer at buyer platform 130. As described in more detail herein, the network transportability of the formula-based decision computation module 210 enables the buyer to modify loan terms and the selection of the purchased vehicle on-the-fly at the purchase location without continual contact with the lender and without negative credit report inquiries.

One or more of the seller platforms 120, the buyer platforms 130, and the on-line financial institution or lender sites 135 can be provided by one or more third party providers operating at various locations in a network ecosystem. It will be apparent to those of ordinary skill in the art that seller platforms 120 or buyer platforms 130 can include or be any of a variety of networked third party information providers or on-line vendors or merchants as described in more detail below. In a particular embodiment, a resource list maintained at the host site 110 can be used as a summary or list of all seller platforms 120, buyer platforms 130, and on-line financial institution or lender sites 135, which users or the host site 110 may visit/access and from which users or the host site 110 can obtain seller data, product data, buyer data, or buyer financial or credit information. The host site 110, seller platforms 120, buyer platforms 130, on-line financial institution or lender sites 135, and user platforms 140 may communicate and transfer data and information in the data network ecosystem shown in FIG. 1 via a wide area data network (e.g., the Internet) 115. Various components of the host site 110 can also communicate internally via a conventional intranet or local area network (LAN) 114.

Networks 115 and 114 are configured to couple one computing device with another computing device. Networks 115 and 114 may be enabled to employ any form of computer readable media for communicating information from one electronic device to another. Network 115 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth™, satellite, or modem and temporary telephone link.

Networks 115 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 115 and 114 may also include an autonomous system of terminals, gateways, routers, and the like connected by wireless radio links or wireless transceivers. These connectors may be configured to move freely and randomly and organize themselves arbitrarily, such that the topology of networks 115 and 114 may change rapidly and arbitrarily.

Networks 115 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 115 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 115 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 115 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The seller platforms 120, buyer platforms 130, and/or the on-line financial institution or lender sites 135 may include any of a variety of providers of network transportable digital data. The network transportable digital data can be transported in any of a family of file formats and associated mechanisms usable to enable a host site 110 and a user platform 140 to receive seller or product data from a seller platform 120, to receive buyer data from a buyer platform 130, and/or to receive buyer financing or credit information from an on-line financial institution or lender sites 135 over the network 115. In one embodiment, the file format can be a Microsoft™ Excel spreadsheet format or a CSV (Comma Separated Values) format; however, the various embodiments are not so limited, and other file formats and transport protocols may be used. For example, data formats other than Excel or CSV or formats other than open/standard formats can be supported by various embodiments. Any electronic file format, such as Microsoft™ Access Database Format (MDB), Portable Document Format (PDF), audio (e.g., Motion Picture Experts Group Audio Layer 3—MP3, and the like), video (e.g., MP4, and the like), and any proprietary interchange format defined by specific sites can be supported by the various embodiments described herein. Moreover, a seller platform 120, a buyer platform 130, and/or an on-line financial institution or lender sites 135 may provide a variety of different data sets or computational modules.

In a particular embodiment, a user platform 140 with one or more client devices enables a user to access data provided by the financing facilitation system 200 via the host 110 and network 115. Client devices of user platform 140 may include virtually any computing device that is configured to send and receive information over a network, such as network 115. Such client devices may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The client devices may also include other computing devices, such as personal computers 142, multiprocessor systems, microprocessor-based or programmable consumer electronics, network PC's, and the like. The client devices may also include other processing devices, such as consumer electronic (CE) devices 146 and/or mobile computing devices 148, which are known to those of ordinary skill in the art. As such, the client devices of user platform 140 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and a full screen color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript™, EXtensible HTML (xHTML), Compact HTML (CHTML), and the like, to display and/or send digital information. In other embodiments, mobile devices can be configured with applications (apps) with which the functionality described herein can be implemented.

The client devices of user platform 140 may also include at least one client application that is configured to receive product data, buyer data, financing data, and/or control data from another computing device via a wired or wireless network transmission. The client application may include a capability to provide and receive textual data, graphical data, video data, audio data, and the like. Moreover, client devices of user platform 140 may be further configured to communicate and/or receive a message, such as through a Short Message Service (SMS), direct messaging (e.g., Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Referring again to FIG. 1, the financing facilitation system 200 for an example embodiment is shown to include a financing facilitation system database 112. The database 112 can be used to retain a variety of information data sets including, but not limited to, seller information, product or product listing information, buyer information, buyer financing or credit information, targeted buyer group or custom audience information, advertisement (ad) data, buyer/seller/product analytics, and the like. It will be apparent to those of ordinary skill in the art that the financing facilitation system database 112 can be locally resident at the host site 110 or remotely located at other server locations or stored in network cloud storage.

Referring again to FIG. 1, host site 110 of an example embodiment is shown to include the financing facilitation system 200. In an example embodiment, financing facilitation system 200 can include a formula-based decision computation module 210, and formula-based decision control module 220. Each of these modules can be implemented as software components executing within an executable environment of financing facilitation system 200 operating on host site 110 or user platform 140. Each of these modules of an example embodiment is described in more detail below in connection with the figures provided herein.

Referring still to FIG. 1, the financing facilitation system 200 can include a formula-based decision computation module 210. The formula-based decision computation module 210 can be configured to perform the processing as described herein. Initially, the formula-based decision computation module 210 can be resident at a lender site 135. The financing facilitation system 200 be configured to provide data communications for the on-line financial institution or lender platforms 135 to enable the networked usage, transfer, or downloading of the formula-based decision computation module 210 from a lender site 135 to the financing facilitation system 200 and executed therein. As a result, the lender-provided formula-based decision computation module 210 can be made resident locally at the host site 110 and the financing facilitation system 200 therein. As illustrated in FIG. 1, the formula-based decision computation module 210 is shown with dashed lines to indicate that the formula-based decision computation module 210 may initially reside with a financial institution or lender 135. In various example embodiments, each of the plurality of financial institutions or lenders 135 may develop or obtain one or more formula-based decision computation modules 210, which embody the particular lender's criteria for defining and approving loan terms for buyers at buyer platforms 130. The lender or loan criteria embodied in the formula-based decision computation module 210 is described in more detail below. As illustrated in FIG. 1, the formula-based decision computation module 210 is shown with dashed lines in the financing facilitation system 200 to indicate that the formula-based decision computation module 210 may be used, transferred, or downloaded to the host site 110 and the financing facilitation system 200 therein via the network 115. As such, the formula-based decision computation module 210 may be locally resident and locally used by a seller at seller platform 120 and a buyer at buyer platform 130.

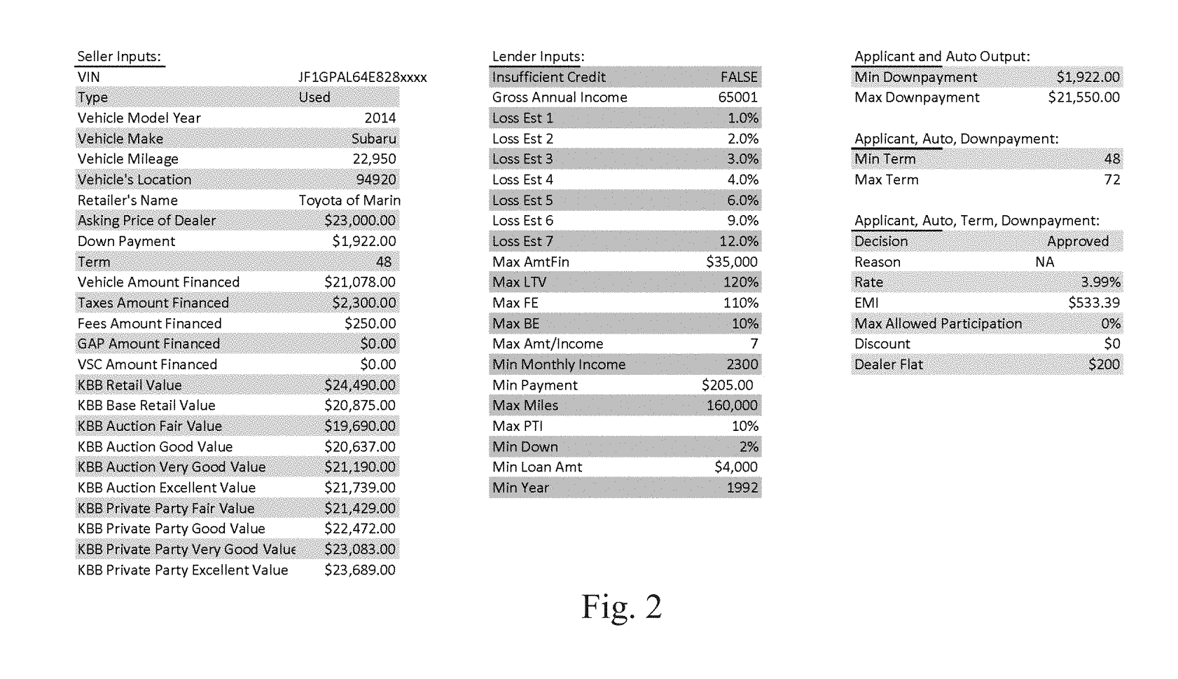

Referring now to FIGS. 2 through 6, the lender or loan criteria embodied in the formula-based decision computation module 210 used, transferred, or downloaded to the financing facilitation system 200 is illustrated. Referring to FIG. 2, a plurality of applicant/buyer, seller, and lender input parameters can be provided to a seller as part of the applicant/buyer's initial loan pre-qualification application. In an example embodiment, these applicant/buyer and seller parameters can include: VIN, vehicle type, vehicle model year, vehicle make, vehicle mileage, vehicle location, retailer name, asking price, down payment amount, term of the loan, amount financed, taxes payable for the amount financed, fees payable for the amount financed, GAP fees payable for the amount financed, VSC fees payable for the amount financed, the estimated retail value of the vehicle (e.g., Kelley Blue Book™ [KBB] retail value), the estimated base retail value of the vehicle, the estimated auction fair value of the vehicle, the estimated auction good value of the vehicle, the estimated auction very good value of the vehicle, the estimated auction excellent value of the vehicle, the estimated private party fair value of the vehicle, the estimated private party good value of the vehicle, the estimated private party very good value of the vehicle, the estimated private party excellent value of the vehicle, and any other parameters needed to determine a corresponding set of loan terms. In an example embodiment, the lender input parameters can include: a sufficiency of credit flag, an applicant gross annual income amount, a set of loss estimate percentages, a maximum amount to be financed, a maximum loan to value ratio, a maximum front end ratio (Max FE=Max front-end, typically a ratio that lenders impose to prevent the borrower from financing more than the car is worth, taking into account taxes, titling costs, and registration fees), a maximum back end ratio (Max BE=Max back-end, typically a ratio or a dollar amount that lenders use to limit the amount of warranty and insurance products that can be financed (GAP, Vehicle Service Contracts, Credit Life and Disability Insurance, etc.), a maximum loan to income ratio, a minimum applicant monthly income amount, a minimum payment amount, a maximum vehicle mileage, a maximum payment to income ratio, a minimum down payment amount, a minimum loan amount, a minimum vehicle production year, and any other parameters needed to determine a corresponding set of loan terms. These applicant/buyer, seller, and lender input parameters serve to enable the seller determine and configure a formula-based decision computation module 210 that can be returned to the seller and/or the applicant/buyer in response to the submittal of an initial loan pre-qualification application.

In response to the receipt of an initial loan pre-qualification application with at least a portion of the parameters described above, the financial institution or lender platform 135 can return a formula-based decision computation module 210 customized for the parameters and information provided in the initial loan pre-qualification application. In response to receiving the customized formula-based decision computation module 210 at a seller platform 120 or a buyer platform 130, the applicant/buyer can use the customized formula-based decision computation module 210 at the seller platform 120 or buyer platform 130 to review and/or modify the initial parameters of the loan proposed by the lender and embodied in the lender or loan criteria.

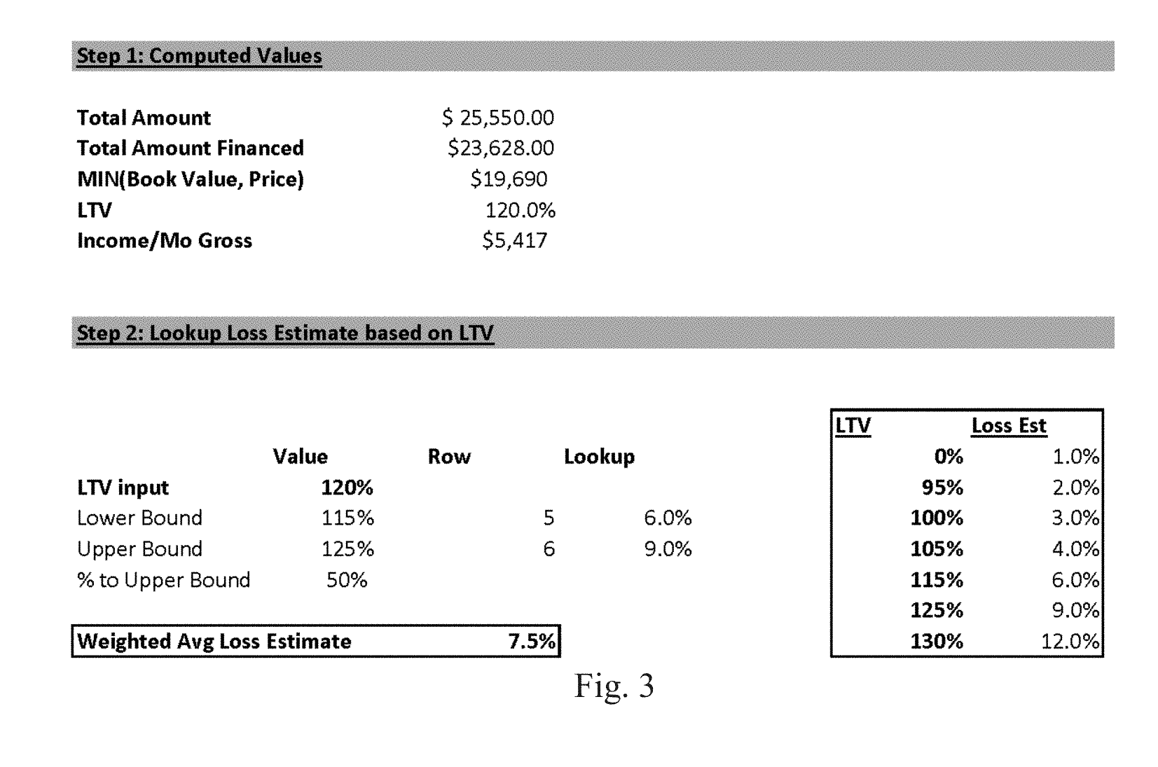

As shown in FIGS. 3 through 6, the applicant/buyer can use the customized formula-based decision computation module 210 locally to perform a series of steps to review, configure, and modify parameters of the loan proposed by the lender. As shown in FIG. 3 for a first operational step in an example embodiment, the customized formula-based decision computation module 210 can locally compute a set of values related to the particular parameters provided by the applicant/buyer, the seller, and the lender as embodied in the customized formula-based decision computation module 210. For example, as shown in FIG. 3, the values computed locally by the customized formula-based decision computation module 210 can include: the total amount or cost of the vehicle (price+taxes and fees), the total amount financed through the loan with the lender (loan amount+taxes and fees), the minimum value comparing the seller asking price and the auction fair value, the loan-to-value (LTV) percentage (amount financed/auction fair value), and the buyer's monthly gross income (yearly income/12). It will be apparent to those of ordinary skill in the art in view of the disclosure herein that a variety of additional data values can be computed locally from the particular parameters provided by the applicant/buyer, the seller, and the lender as embodied in the customized formula-based decision computation module 210. Because the formula-based decision computation module 210 is locally resident at the seller site, the particular parameters provided by the applicant/buyer and the seller can be modified to change the selection of the vehicle to be purchased, change the purchase price, change the down payment amount, or change any of the other applicant/buyer or seller parameters. As a result, the values computed locally by the customized formula-based decision computation module 210 will change in a corresponding manner. Once the applicant/buyer and seller are satisfied with the input parameters and the corresponding set of computed values, the applicant/buyer and seller can move on to the second operational step in the example embodiment.

As shown in FIG. 3 for the second operational step in an example embodiment, the customized formula-based decision computation module 210 can locally compute a set of values related to the estimated loss from the proposed loan based on the loan-to-value data computed in operational step one and based on the parameters provided by the applicant/buyer, the seller, and the lender as embodied in the customized formula-based decision computation module 210. As shown in the example of FIG. 3, the step two local processing performed by the customized formula-based decision computation module 210 can include: obtaining the LTV percentage computed in the first operational step, performing a table look-up to determine an upper and lower bound of the LTV and related loss estimates, and computing a weighted average loss estimate based on the LTV and the corresponding less estimates. The computed weighted average loss estimate can be used in the third operational step in the example embodiment.

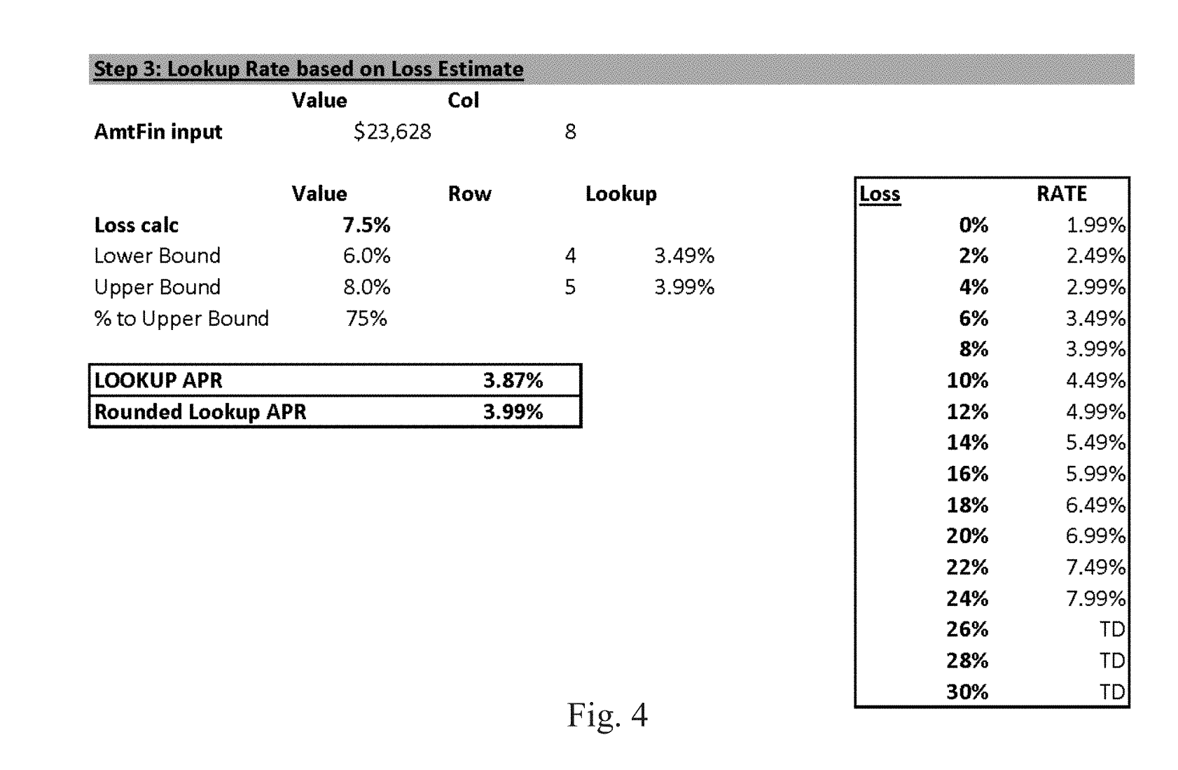

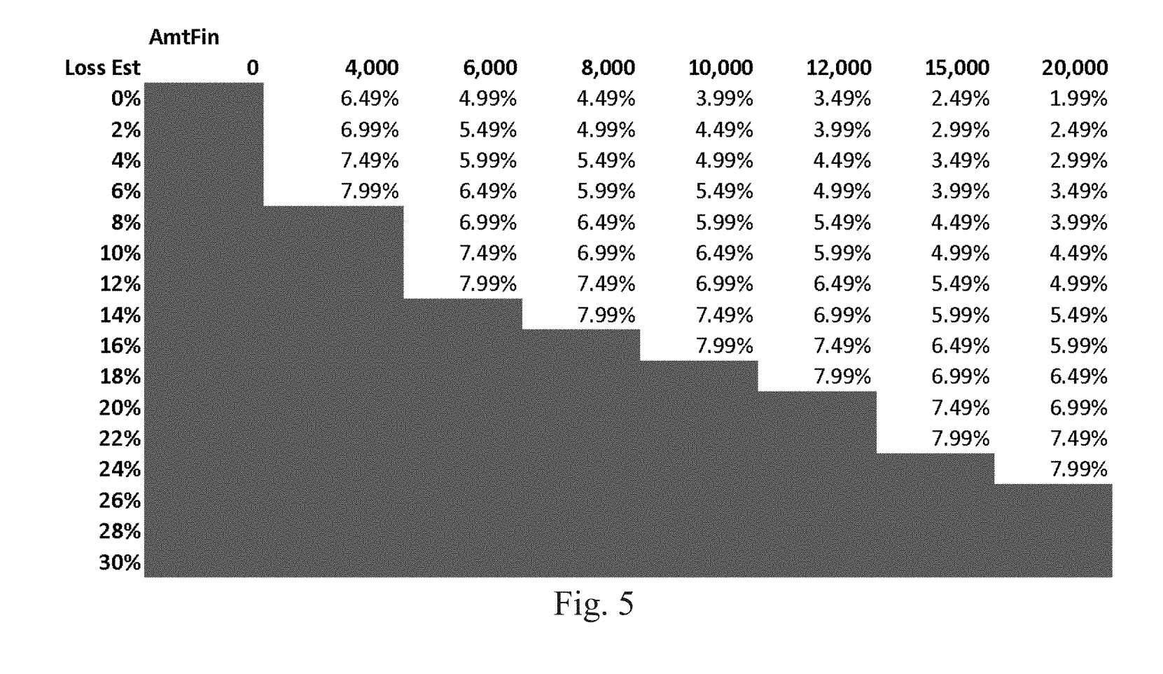

As shown in FIG. 4 for the third operational step in an example embodiment, the customized formula-based decision computation module 210 can locally compute a set of values related to an annual loan interest rate (APR) based on the computed weighted average loss estimate. Initially, the formula-based decision computation module 210 can obtain the amount to be financed by the applicant/buyer as computed in operational step one based on parameters provided by the applicant/buyer and seller. The formula-based decision computation module 210 can use the amount to be financed and the weighted average loss estimate to locally perform a table look-up to determine an annual loan interest rate (APR) for the loan to the applicant/buyer. The related tables in an example are shown in FIGS. 4 and 5. In the example embodiment, the related tables used to determine the APR can also be embedded into the formula-based decision computation module 210. Thus, the applicant/buyer and the seller can modify the terms of the sale and/or the loan and still locally compute a corresponding APR for the lender without having to communicate with the lender or a credit agency each time the sale or loan terms are modified. The computed APR can be used in the fourth operational step in the example embodiment.

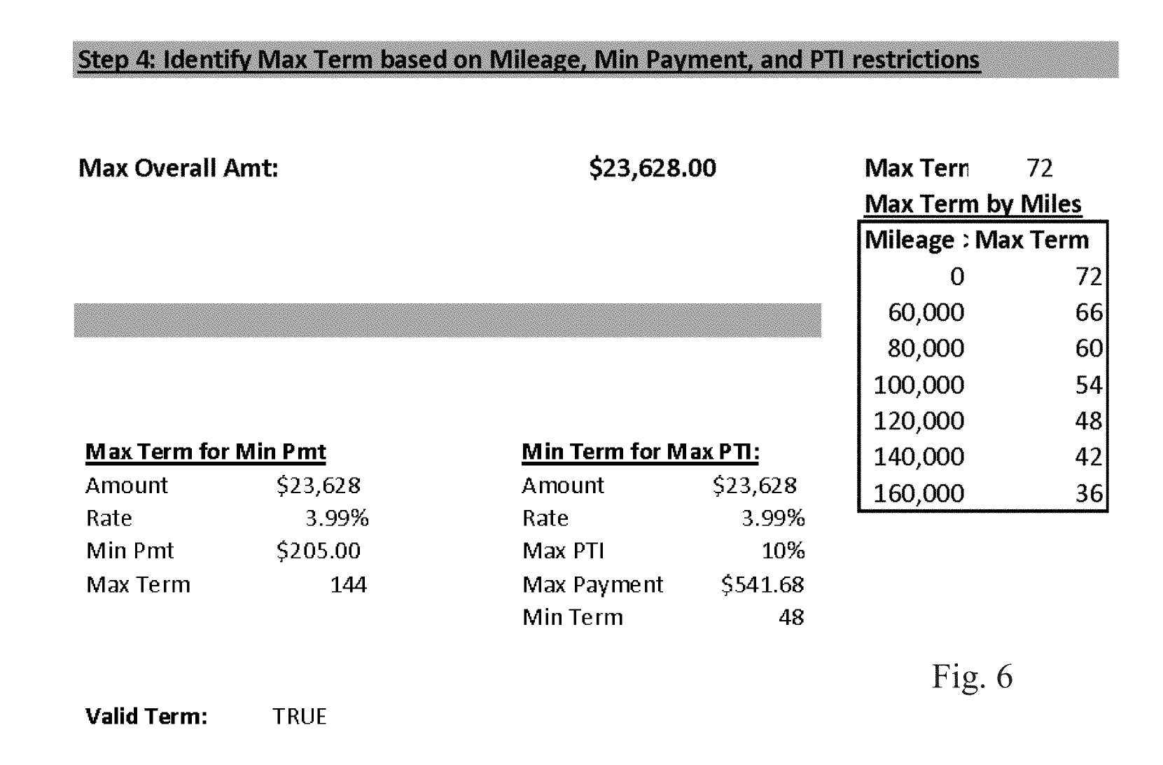

As shown in FIG. 6 for the fourth operational step in an example embodiment, the customized formula-based decision computation module 210 can locally compute a set of values related to the maximum loan term based on the vehicle mileage, the minimum down payment, and the payment-to-income ratio (PTI). In the example embodiment, the formula-based decision computation module 210 can use the vehicle mileage to perform a table look-up to determine a corresponding maximum loan term based on vehicle mileage. The formula-based decision computation module 210 can use the amount financed, the computed APR, and the minimum payment amount to compute a maximum loan term based on the minimum payment amount. The formula-based decision computation module 210 can also use the amount financed, the computed APR, the maximum PTI, and the maximum payment amount to compute a minimum loan term. The values computed in each of the operational steps of the local formula-based informed decision-making process described above can be posted or presented as outputs in the applicant output display area shown in FIG. 2. Any of a plurality of different applicant/buyer output options can be used to present the parameters and computed values corresponding to the applicant/buyer's loan as configured by the applicant/buyer using the formula-based decision computation module 210 locally at the seller location.

Referring again to FIG. 1, the financing facilitation system 200 can include a formula-based decision control module 220. The formula-based decision control module 220 can be configured to perform the processing as described herein. Initially, the formula-based decision control module 220 can be configured to establish, by use of a data processor and the data network 115, a data connection with at least one buyer platform 130 and/or at least one seller platform 120. Additionally, the formula-based decision computation module 210 can be configured to establish, by use of the data processor and the data network 115, a data connection with at least one financial institution or lender platform 135. The formula-based decision control module 220 generally serves to control the network transfer and local usage of the formula-based decision computation module 210. The formula-based decision control module 220 can manage the user interfaces with any of the users of the system. The formula-based decision control module 220 can also manage the network communications between the buyer platforms 130, the seller platforms 120, and the financial institution or lender platforms 135.

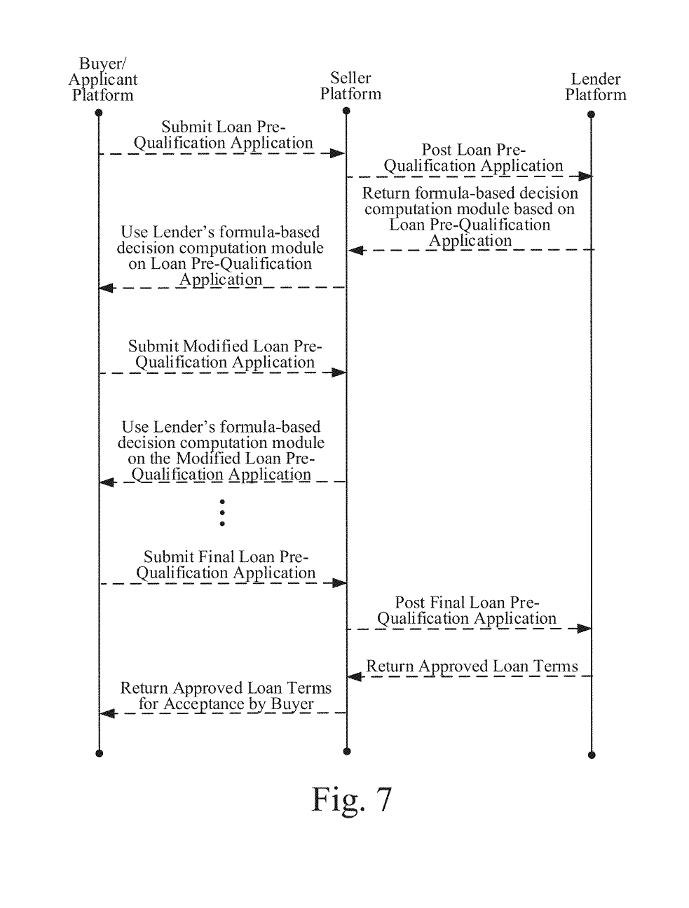

Referring now to FIG. 7, a sequence diagram illustrates the interactions between the buyer platforms 130, the seller platforms 120, and the financial institution or lender platforms 135 for a typical transaction in an example embodiment. Initially, an applicant/buyer can prepare a loan pre-qualification application that includes many of the applicant/buyer and seller parameters as described above. Note that this loan pre-qualification application does not necessarily, and in most cases does not, represent a formal loan application that will result in a hard credit check of the applicant/buyer and all of the regulatory complexity that is required of a formal loan application. The applicant/buyer's preliminary loan pre-qualification application can be forwarded to the seller platform 120 or directly to one or more lender platforms 135. If received at the seller platform 120, the seller can forward or post the applicant/buyer's preliminary loan pre-qualification application to one or more lender platforms 135. The lender can review the received applicant/buyer's preliminary loan pre-qualification application and configure a customized formula-based decision computation module 210 that embodies loan criteria and related data that defines the range of loan terms the lender can be prepared to accept from the applicant/buyer. The customized formula-based decision computation module 210 can be linked, transferred, or downloaded to the seller platform or directly to the applicant/buyer platform. If received at the seller platform 120, the seller can either enable the applicant/buyer to use the customized formula-based decision computation module 210 at the seller site or forward the customized formula-based decision computation module 210 to the applicant/buyer for use at the applicant/buyer site. As described above, the applicant/buyer and the seller can use the customized formula-based decision computation module 210 locally at the seller site to modify parameters and correspondingly adjust the loan terms computed by the customized formula-based decision computation module 210. Once the applicant/buyer and the seller finalize the loan parameters and the corresponding loan terms computed by the customized formula-based decision computation module 210, the final loan pre-qualification application can be submitted or posted to the lender platform 135. The lender at the lender platform 135 can approve the loan terms and return the approved loan terms to the applicant/buyer for acceptance by the applicant/buyer. Because the customized formula-based decision computation module 210 originally embodied loan criteria and related data that defined the range of loan terms the lender could accept from the applicant/buyer, the lender is highly likely to readily approve the final loan terms received from the applicant/buyer and to return the approved loan terms to the applicant/buyer. At this point, the loan process is complete and all parties are satisfied with the outcome.

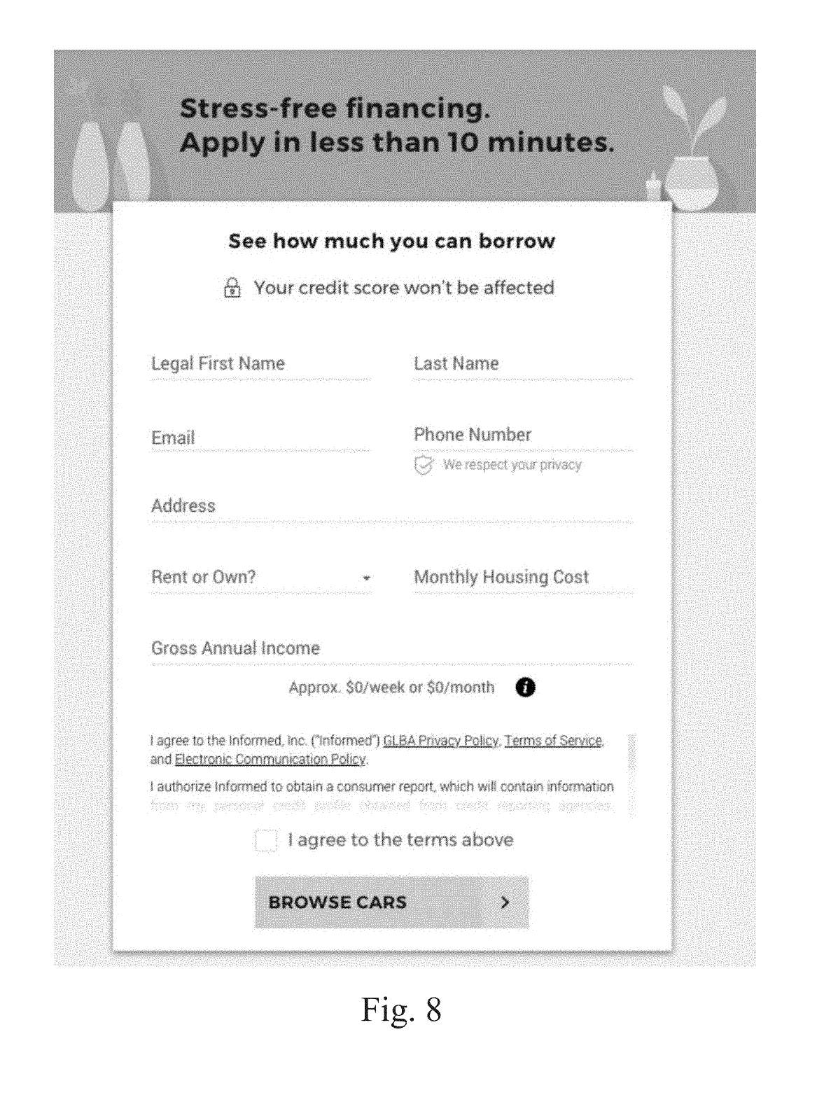

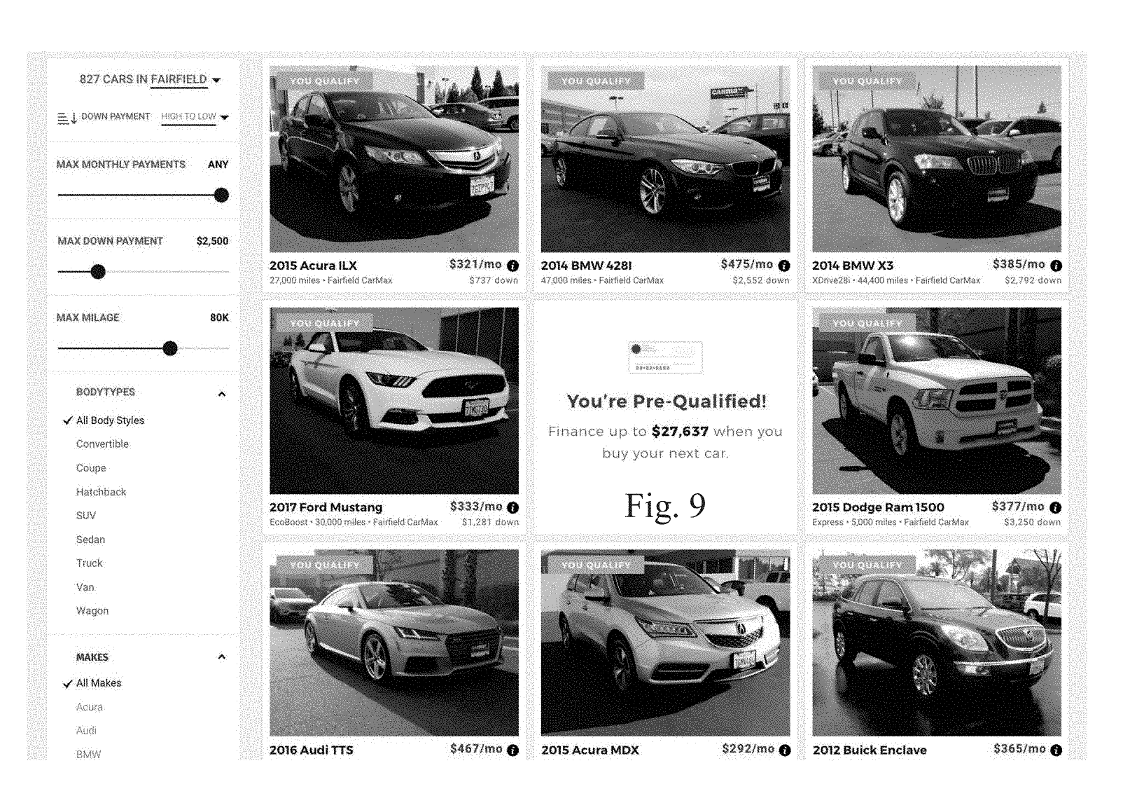

FIGS. 8 and 9 illustrate an example of a user interface presented to an applicant/buyer at an applicant/buyer platform 130 in an example embodiment. In the example embodiment, the formula-based decision control module 220 can manage the user interface on the applicant/buyer platform 130. As shown in FIG. 8, a user interface can enable an applicant/buyer to prepare and submit a preliminary loan pre-qualification application. The parameters provided by the applicant/buyer in an example embodiment can include the applicant/buyer's name, address, social security number, monthly housing cost, and gross annual income amount. This data as part of the applicant/buyer's preliminary loan pre-qualification application can be forwarded to the one or more lender platforms 135. The lender can review the received applicant/buyer's preliminary loan pre-qualification application and configure a customized formula-based decision computation module 210 that embodies loan criteria and related data that defines the range of loan terms the lender can be prepared to accept from the applicant/buyer. The customized formula-based decision computation module 210 can be linked, transferred, or downloaded to the seller platform 120 or directly to the applicant/buyer platform 130. The formula-based decision control module 220 can receive the customized formula-based decision computation module 210 and configure a user interface to present to the applicant/buyer a set of vehicle options that conform to the loan criteria that were embodied in and locally computed by the customized formula-based decision computation module 210. For example, as shown in FIG. 9, a sample user interface presented to an applicant/buyer at an applicant/buyer platform 130 in an example embodiment is shown. Each of the vehicle options presented in the user interface conform to the applicant/buyer's purchase and loan parameters and the customized loan terms presented by a lender via the customized formula-based decision computation module 210. As a result, the applicant/buyer can be reasonably assured that s/he can afford the presented vehicle options. Moreover, the user interface generated by the formula-based decision control module 220 can include user input objects to enable the applicant/buyer to modify the purchase/loan parameters and correspondingly modify the loan terms locally computed by the customized formula-based decision computation module 210. For example, as shown in the sample user interface of FIG. 9, the user can adjust a slider bar via the user interface to modify parameters including: the maximum monthly payment the applicant/buyer can accept, the maximum down payment the applicant/buyer can provide, the maximum vehicle mileage the applicant/buyer can accept, and a variety of other modifiable parameter options. As described above, the modification of any of these modifiable parameter options by the applicant/buyer causes the customized formula-based decision computation module 210 to locally compute the corresponding modified loan terms without the need for continual communications with the lender. The user interface generated by the formula-based decision control module 220 can also re-generate the set of vehicle options presented via the user interface so the listed vehicle options conform to the newly modified purchase/loan parameters and computed loan terms. As a result, after the applicant/buyer provides basic purchase/loan information, the applicant/buyer can see the list of vehicles returned for which the applicant/buyer is pre-qualified to finance, the minimum required down payment, and the monthly loan payment. The applicant/buyer can also see additional vehicles populate as the user scrolls, filters, and/or sorts the list to hone in on the perfect vehicle within their budget. It will be apparent to those of ordinary skill in the art in view of the disclosure herein that the embodiments herein can be used with multiple lenders and multiple vehicles, multiple lenders and one vehicle, one lender and multiple vehicles, and any such variations.

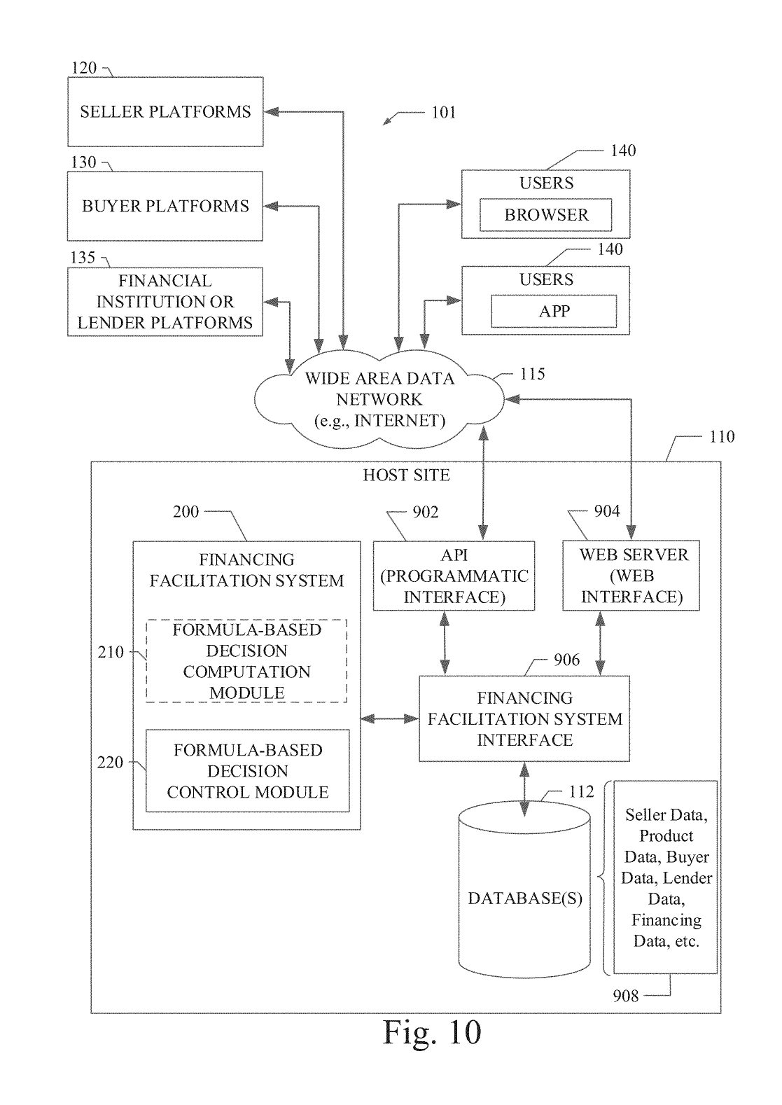

Referring now to FIG. 10, another example embodiment 101 of a networked system in which various embodiments may operate is illustrated. In the embodiment illustrated, the host site 110 is shown to include the financing facilitation system 200. The financing facilitation system 200 is shown to include the customized formula-based decision computation module 210 and the formula-based decision control module 220, as described above. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the financing facilitation system 200 either directly or via an interface 906. The financing facilitation system 200 may be configured to access a data storage device 112 either directly or via the interface 906.

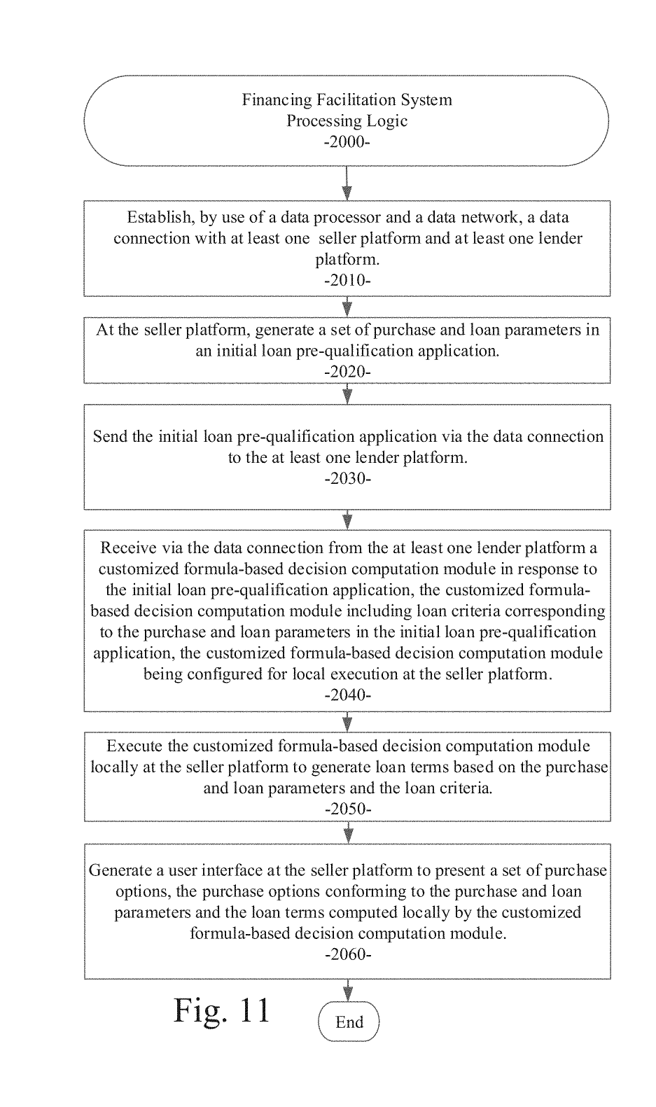

Referring now to FIG. 11, a processing flow diagram illustrates an example embodiment of a method implemented by the financing facilitation system 200 as described herein. The method 2000 of an example embodiment includes: establishing, by use of a data processor and a data network, a data connection with at least one seller platform and at least one lender platform (processing block 2010); at the seller platform, generating a set of purchase and loan parameters in an initial loan pre-qualification application (processing block 2020); sending the initial loan pre-qualification application via the data connection to the at least one lender platform (processing block 2030); receiving via the data connection from the at least one lender platform a customized formula-based decision computation module in response to the initial loan pre-qualification application, the customized formula-based decision computation module including loan criteria corresponding to the purchase and loan parameters in the initial loan pre-qualification application, the customized formula-based decision computation module being configured for local execution at the seller platform (processing block 2040); executing the customized formula-based decision computation module locally at the seller platform to generate loan terms based on the purchase and loan parameters and the loan criteria (processing block 2050); and generating a user interface at the seller platform to present a set of purchase options, the purchase options conforming to the purchase and loan parameters and the loan terms computed locally by the customized formula-based decision computation module (processing block 2060).

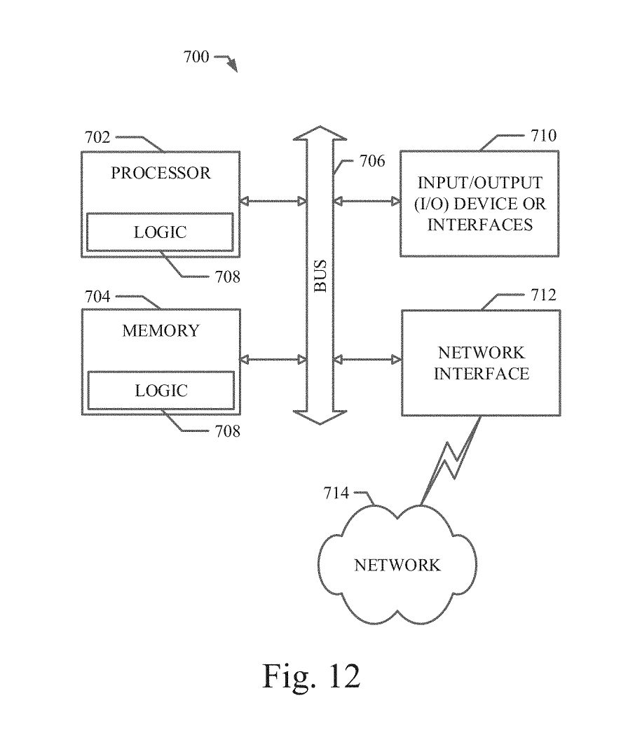

FIG. 12 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that stores the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

As described herein for various example embodiments, a system and method for the generation and use of local formulas for informed decision-making are disclosed. In various embodiments, a software application program is used to enable the transfer and execution of a local formula-based decision computation module for targeted buyer groups or audiences to present tailored financing information on the display screen of a computing or communication system, including mobile devices. As described above, in a variety of contexts, the financing facilitation system 200 of an example embodiment can be configured to automatically obtain a formula-based decision computation module from one or more 3rd party sites via a data network to facilitate the user experience of searching, purchasing, financing, test driving, transferring title, registering, and insuring a specific vehicle, all from the convenience of a portable electronic device, such as a smartphone. This collection of vehicle-related transactions has traditionally been possible only via multiple, personal interactions with a plurality of different parties at different locations. The embodiments as presently disclosed and claimed enable these disparate transactions to be integrated into a single set of electronic interactions with a mobile device or other computing device. As such, the various embodiments as described herein are necessarily rooted in computer and network technology and serve to improve these technologies when applied in the manner as presently claimed. In particular, the various embodiments described herein improve the use of mobile device technology and data network technology in the context of product purchase and financing transactions via electronic means.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
establishing, by use of a data processor and a data network, a data connection with at least one seller platform and at least one lender platform;
at the seller platform, generating a set of purchase and loan parameters in an initial loan pre-qualification application;
sending the initial loan pre-qualification application via the data connection to the at least one lender platform;
receiving via the data connection from the at least one lender platform a customized formula-based decision computation module in response to the initial loan pre-qualification application, the customized formula-based decision computation module including loan criteria corresponding to the purchase and loan parameters in the initial loan pre-qualification application, the customized formula-based decision computation module being configured for local execution at the seller platform;
executing the customized formula-based decision computation module locally at the seller platform to generate loan terms based on the purchase and loan parameters and the loan criteria; and
generating a user interface at the seller platform to present a set of purchase options, the purchase options conforming to the purchase and loan parameters and the loan terms computed locally by the customized formula-based decision computation module.

2. The method of claim 1 further including enabling a user at the seller platform to modify the purchase and loan parameters, and to execute the customized formula-based decision computation module locally at the seller platform to generate modified loan terms based on the modified purchase and loan parameters and the loan criteria.

3. The method of claim 1 wherein the set of purchase and loan parameters includes an applicant/buyer's name, address, social security number, monthly housing cost, and gross annual income amount.

4. The method of claim 1 wherein the loan criteria includes loss estimate data, annual percentage rate data, and loan term data.

5. The method of claim 1 wherein the customized formula-based decision computation module locally computes a loan-to-value percentage, an average loss estimate, an annual percentage rate, and a maximum loan term.

6. The method of claim 1 wherein the user interface includes user input objects to enable a user to modify the purchase and loan parameters and correspondingly cause the customized formula-based decision computation module to locally modify the computed loan terms.

7. The method of claim 1 wherein the user interface includes a slider bar to enable a user to modify the purchase and loan parameters and correspondingly cause the customized formula-based decision computation module to locally modify the computed loan terms.

8. A system comprising:
a data processor;
a network interface, in data communication with the data processor, for communication on a data network; and
a financing facilitation system, executable by the data processor, to:
establish, by use of the data processor and the data network, a data connection with at least one seller platform and at least one lender platform;
at the seller platform, generate a set of purchase and loan parameters in an initial loan pre-qualification application;
send the initial loan pre-qualification application via the data connection to the at least one lender platform;
receive via the data connection from the at least one lender platform a customized formula-based decision computation module in response to the initial loan pre-qualification application, the customized formula-based decision computation module including loan criteria corresponding to the purchase and loan parameters in the initial loan pre-qualification application, the customized formula-based decision computation module being configured for local execution at the seller platform;
execute the customized formula-based decision computation module locally at the seller platform to generate loan terms based on the purchase and loan parameters and the loan criteria; and
generate a user interface at the seller platform to present a set of purchase options, the purchase options conforming to the purchase and loan parameters and the loan terms computed locally by the customized formula-based decision computation module.

9. The system of claim 8 being further configured to enable a user at the seller platform to modify the purchase and loan parameters, and to execute the customized formula-based decision computation module locally at the seller platform to generate modified loan terms based on the modified purchase and loan parameters and the loan criteria.

10. The system of claim 8 wherein the set of purchase and loan parameters includes an applicant/buyer's name, address, social security number, monthly housing cost, and gross annual income amount.

11. The system of claim 8 wherein the loan criteria includes loss estimate data, annual percentage rate data, and loan term data.

12. The system of claim 8 wherein the customized formula-based decision computation module being configured to locally compute a loan-to-value percentage, an average loss estimate, an annual percentage rate, and a maximum loan term.

13. The system of claim 8 wherein the user interface being configured to present user input objects to enable a user to modify the purchase and loan parameters and correspondingly cause the customized formula-based decision computation module to locally modify the computed loan terms.

14. The system of claim 8 wherein the user interface being configured to present a slider bar to enable a user to modify the purchase and loan parameters and correspondingly cause the customized formula-based decision computation module to locally modify the computed loan terms.

15. A non-transitory machine-useable storage medium embodying instructions which, when executed by a machine, cause the machine to:
establish, by use of the data processor and the data network, a data connection with at least one seller platform and at least one lender platform;
at the seller platform, generate a set of purchase and loan parameters in an initial loan pre-qualification application;
send the initial loan pre-qualification application via the data connection to the at least one lender platform;
receive via the data connection from the at least one lender platform a customized formula-based decision computation module in response to the initial loan pre-qualification application, the customized formula-based decision computation module including loan criteria corresponding to the purchase and loan parameters in the initial loan pre-qualification application, the customized formula-based decision computation module being configured for local execution at the seller platform;
execute the customized formula-based decision computation module locally at the seller platform to generate loan terms based on the purchase and loan parameters and the loan criteria; and
generate a user interface at the seller platform to present a set of purchase options, the purchase options conforming to the purchase and loan parameters and the loan terms computed locally by the customized formula-based decision computation module.

16. The non-transitory machine-useable storage medium of claim 15 being further configured to enable a user at the seller platform to modify the purchase and loan parameters, and to execute the customized formula-based decision computation module locally at the seller platform to generate modified loan terms based on the modified purchase and loan parameters and the loan criteria.

17. The non-transitory machine-useable storage medium of claim 15 wherein the set of purchase and loan parameters includes an applicant/buyer's name, address, social security number, monthly housing cost, and gross annual income amount.

18. The non-transitory machine-useable storage medium of claim 15 wherein the loan criteria includes loss estimate data, annual percentage rate data, and loan term data.

19. The non-transitory machine-useable storage medium of claim 15 wherein the customized formula-based decision computation module being configured to locally compute a loan-to-value percentage, an average loss estimate, an annual percentage rate, and a maximum loan term.

20. The non-transitory machine-useable storage medium of claim 15 wherein the user interface being configured to present user input objects to enable a user to modify the purchase and loan parameters and correspondingly cause the customized formula-based decision computation module to locally modify the computed loan terms.
